(19) United States
(12) Patent Application Publication
(10) Pub. No.: US 2026/0242166 A1
(43) Pub. Date: Aug. 20, 2026

(54) MEDIUM FEEDING DEVICE AND RECORDING APPARATUS

(71) Applicant: SEIKO EPSON CORPORATION, TOKYO (JP)

(72) Inventors: Ryoichi MORISAWA, SHIOJIRI-SHI (JP); Kazutoshi MATSUZAKI, SHIOJIRI-SHI (JP); Atsushi NAKAZAWA, MATSUMOTO-SHI (JP); Yuji MIYAMOTO, SHIOJIRI-SHI (JP); Makoto ISHIGURO, MATSUMOTO-SHI (JP)

(21) Appl. No.: 19/545,088

(22) Filed: Feb. 20, 2026

(30) Foreign Application Priority Data
Feb. 20, 2025 (JP) 2025-025681

(51) Int. Cl. B65H 7/18; B65H 1/08; B65H 3/06

(52) U.S. Cl. CPC B65H 7/18; B65H 1/08; B65H 3/06; B65H 2515/805; B65H 2515/84; B65H 2801/39

(57) ABSTRACT

A medium feeding device includes a stacking portion on which a medium is stacked, a feeding portion configured to feed the medium stacked on the stacking portion, a conveying roller configured to convey the medium fed by the feeding portion, a separation portion configured to nip the medium together with the conveying roller to separate the medium, a raising and lowering portion configured to raise and lower the stacking portion, and a control unit configured to control the raising and lowering portion. The feeding portion rises by coming into contact with the medium stacked on the stacking portion as the stacking portion is raised by the raising and lowering portion. In a first state, the control unit raises the stacking portion such that the feeding portion is disposed at a first position. In a second state where a wear amount of the conveying roller is estimated to be greater than a wear amount in the first state, the control unit raises the stacking portion such that the feeding portion is disposed at a second position above the first position.

The present application is based on, and claims priority from JP Application Serial Number 2025-025681, filed Feb. 20, 2025, the disclosure of which is hereby incorporated by reference herein in its entirety.

### BACKGROUND

### 1. Technical Field

The present disclosure relates to a medium feeding device and a recording apparatus.

### 2. Related Art

For example, JP-A-2020-45242 discloses a sheet feeding device including a guide sheet that guides a leading end of a sheet fed by a pickup roller to a feed roller, and a position changing mechanism that moves the guide sheet so as to come into contact with and separate from the feed roller. In the sheet feeding device which is an example of a medium feeding device, the guide sheet is installed between the pickup roller and the feed roller. Therefore, the position changing mechanism is provided near the feed roller. Accordingly, the guide sheet can appropriately guide the sheet fed by the pickup roller to the feed roller.

JP-A-2020-45242 is an example of the related art.

However, such a medium feeding device requires a space for providing the position changing mechanism for moving the guide sheet. Therefore, it is desired to achieve space saving.

### SUMMARY

A medium feeding device according to an aspect of the present disclosure includes: a stacking portion on which a medium is stacked; a feeding portion configured to feed the medium stacked on the stacking portion; a conveying roller configured to convey the medium fed by the feeding portion; a separation portion configured to nip the medium together with the conveying roller to separate the medium; a raising and lowering portion configured to raise and lower the stacking portion; and a control unit configured to control the raising and lowering portion, in which the feeding portion rises by coming into contact with the medium stacked on the stacking portion as the stacking portion is raised by the raising and lowering portion, and in a first state, the control unit raises the stacking portion such that the feeding portion is disposed at a first position, and in a second state where a wear amount of the conveying roller is estimated to be greater than a wear amount in the first state, the control unit raises the stacking portion such that the feeding portion is disposed at a second position above the first position.

A recording apparatus according to an aspect of the present disclosure includes: a stacking portion on which a medium is stacked; a feeding portion configured to feed the medium stacked on the stacking portion; a conveying roller configured to convey the medium fed by the feeding portion; a separation portion configured to nip the medium together with the conveying roller to separate the medium; a raising and lowering portion configured to raise and lower the stacking portion; a recording unit configured to perform recording on the medium conveyed by the conveying roller; and a control unit configured to control the recording unit and the raising and lowering portion, in which the feeding portion rises by coming into contact with the medium stacked on the stacking portion as the stacking portion is raised by the raising and lowering portion, and in a first state, the control unit raises the stacking portion such that the feeding portion is disposed at a first position, and in a second state where a wear amount of the conveying roller is estimated to be greater than a wear amount in the first state, the control unit raises the stacking portion such that the feeding portion is disposed at a second position above the first position.

### BRIEF DESCRIPTION OF THE DRAWINGS

FIG. 1 is a schematic diagram showing a recording apparatus according to a first embodiment.

FIG. 2 is a schematic diagram showing a medium feeding device according to the first embodiment.

FIG. 3 is a flowchart showing position adjustment control processing according to the first embodiment.

FIG. 4 is a schematic diagram showing a medium feeding device according to a second embodiment.

FIG. 5 is a flowchart showing position adjustment control processing according to a third embodiment.

FIG. 6 is a flowchart showing position adjustment control processing according to a fourth embodiment.

FIG. 7 is a flowchart showing position adjustment control processing according to a fifth embodiment.

### DESCRIPTION OF EMBODIMENTS

### First Embodiment

Hereinafter, a medium feeding device and a recording apparatus according to an embodiment will be described with reference to the drawings. In the drawings, the direction of gravity is indicated by a Z axis assuming that the recording apparatus is placed on a horizontal plane. Directions along the horizontal plane are indicated by an X axis and a Y axis. The X axis, the Y axis, and the Z axis intersect one another. In the following description, a direction along the X axis is referred to as a width direction X. A direction along the Y axis is indicated as a depth direction Y. A direction parallel to the Z axis is indicated as a vertical direction Z. In the following description, when viewed from a front surface of the recording apparatus, the near side is referred to as the front, and the far side is referred to as the rear.

### Configuration of Recording Apparatus 11

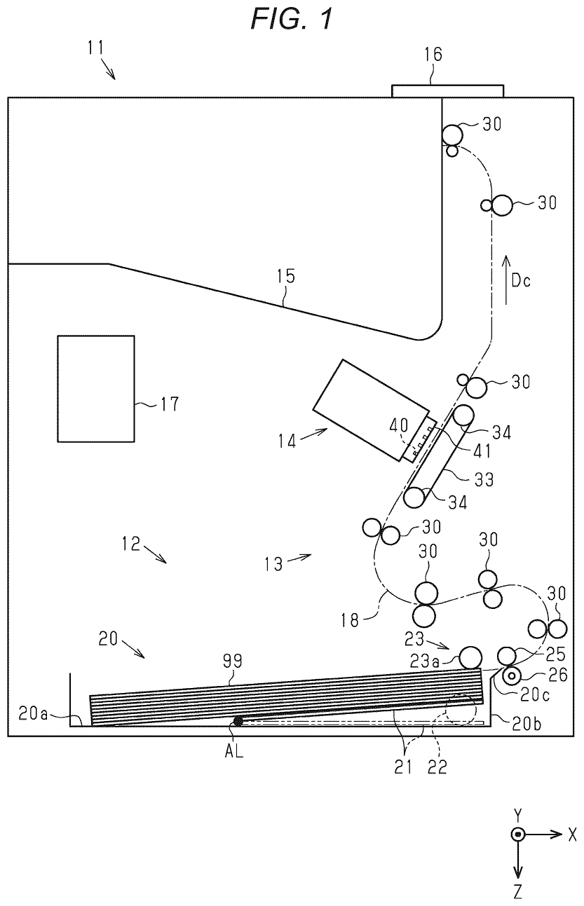

As shown in FIG. 1, a recording apparatus 11 is configured to record an image on a medium 99. The recording apparatus 11 may be an inkjet printer that performs recording by ejecting an ink, which is an example of a liquid, onto the medium 99 such as a sheet.

The recording apparatus 11 includes a medium feeding device 12, a conveying portion 13, and a recording unit 14. The recording apparatus 11 may include a stacker 15 and an operation panel 16. The recording apparatus 11 includes a control unit 17.

The medium feeding device 12 can accommodate the medium 99. The medium feeding device 12 is configured to feed the accommodated medium 99 to the conveying portion 13. The medium feeding device 12 is configured to feed the accommodated uppermost media 99 one by one to the conveying portion 13.

The conveying portion 13 conveys the medium 99. The conveying portion 13 conveys the medium 99 fed from the medium feeding device 12 along a conveying path 18. In FIG. 1, the conveying path 18 is indicated by a one-dot chain line. The conveying path 18 is a path coupling the medium feeding device 12 and the stacker 15. The conveying portion 13 conveys the medium 99 in a conveying direction Dc. The conveying direction Dc is a direction along the conveying path 18.

The conveying portion 13 conveys the medium 99 fed from the medium feeding device 12 to a recording position along the recording unit 14. The conveying portion 13 conveys the medium 99 recorded by the recording unit 14 from the recording position along the conveying path 18 and discharges the medium 99 to the stacker 15. The stacker 15 receives the conveyed medium 99.

The conveying portion 13 includes one or more drive rollers 30. The drive roller 30 conveys the medium 99 along the conveying path 18. The drive roller 30 conveys the medium 99 along the conveying path 18 by rotating according to a driving force from a roller drive unit (not shown). The roller drive unit may be a motor.

The conveying portion 13 may include a conveying belt 33 and a pair of pulleys 34. The conveying belt 33 may be endless. The conveying belt 33 is wound around the pair of pulleys 34. The conveying belt 33 faces the recording unit 14 with the conveying path 18 interposed therebetween. The conveying belt 33 supports a part of the medium 99 in a flat state. The conveying belt 33 conveys the medium 99 by rotating in a state of adsorbing the medium 99.

The recording unit 14 performs recording on the medium 99 conveyed by the conveying portion 13. The recording unit 14 may include a plurality of nozzles 40. The recording unit 14 may have a nozzle surface 41. The plurality of nozzles 40 are open in the nozzle surface 41. Each of the plurality of nozzles 40 ejects a liquid. The recording unit 14 is provided such that the nozzle surface 41 is inclined with respect to the horizontal plane, but may be provided such that the nozzle surface 41 is horizontal.

The recording unit 14 performs recording on the medium 99 by ejecting the liquid onto the medium 99 supported by the conveying belt 33. The recording unit 14 may be of a line type. The line type recording unit 14 ejects the liquid onto the conveyed medium 99 in a state where the recording unit 14 is stopped. The recording unit 14 may be of a serial type. The serial type recording unit 14 ejects the liquid while moving.

The operation panel 16 includes a display portion and an operation portion. The display portion is configured to display information. The operation portion allows a user to input an instruction. The operation portion may be a button or a touch panel.

The control unit 17 comprehensively controls driving of each mechanism in the recording apparatus 11. The control unit 17 controls various operations executed by the recording apparatus 11. The control unit 17 controls, for example, the recording unit 14. The medium feeding device 12 may include the control unit 17.

The control unit 17 can be implemented as a circuit including α: one or more processors that execute various kinds of processing in accordance with a computer program, β: one or more dedicated hardware circuits that execute at least some processing among the various kinds of processing, or γ: a combination of α and β. The hardware circuit is, for example, an application specific integrated circuit. The processor includes a CPU and a memory such as a RAM and a ROM, and the memory stores program codes or commands configured to cause the CPU to execute the processing. The memory, that is, a computer-readable medium, includes any readable medium that can be accessed by a general-purpose or dedicated computer.

### Configuration of Medium Feeding Device 12

The medium feeding device 12 may include a cassette 20. The cassette 20 can accommodate the medium 99. The cassette 20 may be able to accommodate a plurality of media 99 in a stacked state. The cassette 20 may be slidable with respect to the medium feeding device 12.

The cassette 20 may include a bottom plate portion 20a and a side wall portion 20b. The side wall portion 20b is provided around the bottom plate portion 20a so as to protrude upward from the bottom plate portion 20a.

The cassette 20 may include a guide portion 20c. The guide portion 20c may be provided at an upper end of the side wall portion 20b. The guide portion 20c has a guide surface that guides the medium 99 fed by a feeding roller 23a to be described later to a separation portion 26. The guide surface may be a surface inclined with respect to the horizontal plane.

The cassette 20 includes a stacking portion 21. That is, the medium feeding device 12 includes the stacking portion 21. The recording apparatus 11 includes the stacking portion 21. The stacking portion 21 is provided on the bottom plate portion 20a. On the stacking portion 21, the media 99 can be stacked. On the stacking portion 21 together with the bottom plate portion 20a, the media 99 can be stacked.

The stacking portion 21 is rotatable about a rotation axis AL. The rotation axis AL is an axis along the depth direction Y. The rotation axis AL is an axis intersecting a feeding direction FD of the medium 99 to be described later and the vertical direction Z.

The medium feeding device 12 includes a raising and lowering portion 22. That is, the recording apparatus 11 includes the raising and lowering portion 22. The raising and lowering portion 22 transmits a driving force to the stacking portion 21 via a power transmission portion (not shown). The raising and lowering portion 22 transmits the driving force to the stacking portion 21 to raise and lower a tip portion of the stacking portion 21. The tip portion of the stacking portion 21 is an end portion of the stacking portion 21 on a side where a separation roller 26a to be described later is disposed. That is, the raising and lowering portion 22 transmits the driving force to the stacking portion 21 to raise and lower the stacking portion 21. The raising and lowering portion 22 is controlled by the control unit 17. That is, the control unit 17 controls the raising and lowering portion 22.

In particular, the raising and lowering portion 22 raises and lowers the stacking portion 21 by rotating the stacking portion 21 about the rotation axis AL. In this manner, the stacking portion 21 is configured to be rotatable about the rotation axis AL by receiving the driving force from the raising and lowering portion 22. The stacking portion 21 can be raised and lowered in the vertical direction Z. The raising and lowering portion 22 raises and lowers the stacking portion 21 at a predetermined speed.

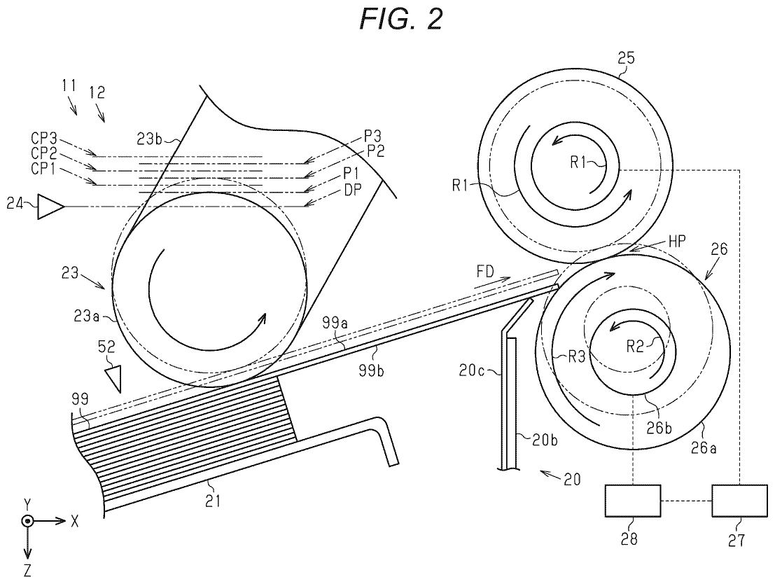

As shown in FIG. 2, the medium feeding device 12 includes a feeding portion 23. The feeding portion 23 feeds the media 99 accommodated in the cassette 20 one by one to the conveying path 18. The feeding portion 23 feeds the media 99 stacked on the stacking portion 21 one by one to the conveying path 18. The feeding portion 23 feeds the media 99 one by one in the feeding direction FD. The feeding direction FD may be a direction inclined upward with respect to the width direction X.

The feeding portion 23 may include the feeding roller 23a and an arm 23b. The feeding roller 23a is rotatably supported at a tip portion of the arm 23b. The arm 23b is rotatable about a rotation axis at a base end portion (not shown). The rotation axis of the arm 23b is an axis along the depth direction Y. In this manner, the feeding portion 23 is swingable in the vertical direction Z.

The feeding roller 23a comes into contact with the uppermost medium 99 stacked on the stacking portion 21. The feeding roller 23a rises by coming into contact with the uppermost medium 99 stacked on the stacking portion 21 as the stacking portion 21 is raised.

The feeding roller 23a is rotatable by a driving force from a feeding drive unit (not shown). The feeding roller 23a feeds the medium 99 to the conveying path 18 by rotating in a state of being in contact with the medium 99.

Accordingly, the feeding portion 23 feeds the medium 99 stacked on the stacking portion 21. The feeding portion 23 rises by coming into contact with the medium 99 stacked on the stacking portion 21 as the stacking portion 21 is raised by the raising and lowering portion 22.

The medium feeding device 12 may include a detection unit 24. The detection unit 24 detects a position of the feeding portion 23. The detection unit 24 detects that the feeding portion 23 has been raised to a detection position DP. The detection unit 24 is, for example, an optical sensor, but may be a contact sensor.

The feeding portion 23 is disposed at an initial position (not shown) in an initial state. The initial position is below the detection position DP. The feeding portion 23 can be disposed at a first position P1, a second position P2, and a third position P3 by the raising and lowering portion 22 raising the stacking portion 21. The first position P1 is above the detection position DP. The second position P2 is above the first position P1. The third position P3 is above the second position P2.

The medium feeding device 12 includes a conveying roller 25 and the separation portion 26. That is, the recording apparatus 11 includes the conveying roller 25 and the separation portion 26. The conveying roller 25 is provided downstream of the feeding portion 23 in the conveying path 18. The conveying roller 25 is rotatable about a rotation axis along the depth direction Y. The conveying roller 25 conveys the medium 99 along the conveying path 18 by rotating in a state of nipping the medium 99 fed by the medium feeding device 12 with the separation portion 26. The conveying roller 25 may be, for example, a rubber roller having elasticity.

The separation portion 26 is provided downstream of the feeding portion 23 in the conveying path 18. The separation portion 26 is provided at a position sandwiching the conveying path 18 with the conveying roller 25. The separation portion 26 is biased toward the conveying roller 25 by a biasing force from a biasing portion (not shown). The separation portion 26 is rotatable about a rotation axis along the depth direction Y.

The separation portion 26 may include the separation roller 26a and a rotation shaft 26b. The separation roller 26a may be, for example, a rubber roller having elasticity. The rotation shaft 26b extends along the depth direction Y.

The separation portion 26 separates, one by one, the media 99 sent in an overlapping state. The separation portion 26 nips the media 99 together with the conveying roller 25 and separates the media 99. The separation portion 26 presses and retains the second and subsequent media 99 from the top in the cassette 20. The separation portion 26 is a rotating body that can take a state of being driven by the conveying roller 25 and a state of being stopped or being reversed with respect to the conveying roller 25.

The conveying roller 25 and the separation roller 26a can nip the medium 99 at a nipping position HP. The nipping position HP is a position where the medium 99 is nipped by the separation portion 26 and the conveying roller 25. The nipping means to pinch the medium 99 in the thickness direction.

The conveying roller 25 comes into contact with a first surface 99a of the medium 99 and conveys the medium 99 in the feeding direction FD. The conveying roller 25 conveys the medium 99 by rotating in a state of nipping the medium 99 with the separation roller 26a. The conveying roller 25 is rotatable in a forward rotation direction R1 about the rotation shaft 26b. The forward rotation direction R1 is a direction in which the medium 99 is fed in the feeding direction FD.

The separation roller 26a comes into contact with a second surface 99b of the medium 99. The separation roller 26a is rotatable about the rotation shaft 26b in a reverse rotation direction R2 and a forward rotation direction R3. The forward rotation direction R3 is a direction in which the medium 99 is fed in the feeding direction FD. The reverse rotation direction R2 is a direction opposite to the forward rotation direction R3. The separation roller 26a is not fixed to the rotation shaft 26b. Therefore, the separation roller 26a is rotatable so as to slide on the rotation shaft 26b.

The medium feeding device 12 may include a drive unit 27 and a torque limiter 28. The drive unit 27 can transmit power to the separation portion 26 via the torque limiter 28. The drive unit 27 may be a motor.

The drive unit 27 rotates the conveying roller 25 in the forward rotation direction R1. Specifically, the drive unit 27 rotates the rotation shaft 26b in the forward rotation direction R1. The drive unit 27 rotates the separation roller 26a in the reverse rotation direction R2. Specifically, the drive unit 27 rotates the rotation shaft 26b in the reverse rotation direction R2. However, when the separation roller 26a is in contact with the conveying roller 25 that is rotating, the separation roller 26a rotates in the forward rotation direction R3 following the conveying roller 25.

The torque limiter 28 switches transmission of the driving force to the separation roller 26a. When the rotation directions of the separation roller 26a and the rotation shaft 26b are different from each other, the torque limiter 28 may apply a rotation load to the separation roller 26a. That is, when the rotation shaft 26b rotates in the reverse rotation direction R2 and the separation roller 26a rotates in the forward rotation direction R3, the torque limiter 28 may apply a rotation load to the separation roller 26a. When the rotation directions of the separation roller 26a and the rotation shaft 26b are the same, the torque limiter 28 may not apply a rotation load to the separation roller 26a. That is, when the rotation shaft 26b and the separation roller 26a rotate in the reverse rotation direction R2, the torque limiter 28 may not apply a rotation load to the separation roller 26a.

### Position Adjustment Control Processing

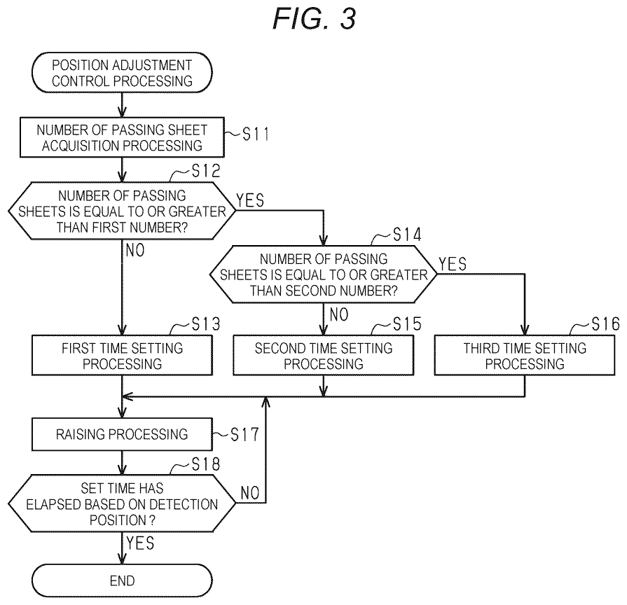

Position adjustment control processing will be described with reference to FIG. 3. The position adjustment control processing is processing executed by the control unit 17 when a recording start instruction is received, or may be processing executed by the control unit 17 every time the medium 99 is fed.

As shown in FIG. 3, in step S11, the control unit 17 executes number of passing sheet acquisition processing. In this processing, the control unit 17 acquires the number of the media 99 conveyed by the conveying roller 25 as the number of passing sheets. That is, the number of passing sheets is the number of the media 99 conveyed by the conveying roller 25. When the conveying roller 25 has been replaced, the number of passing sheets may be reset.

In processing different from the position adjustment control processing, the control unit 17 may count the number of passing sheets for each medium 99 subjected to printing based on the recording start instruction. The control unit 17 may count the number of passing sheets based on a result of detecting the medium 99 conveyed by the conveying portion 13 by a sensor (not shown).

In step S12, the control unit 17 determines whether the number of passing sheets is equal to or greater than a first number. In this processing, the control unit 17 determines that the state is a first state when it is determined the number of passing sheets is smaller than the first number. The first state is a state where the medium 99 is estimated to be normally fed to the nipping position HP by the feeding portion 23. The first number may be, for example, 50,000.

When the control unit 17 determines that the number of passing sheets is equal to or greater than the first number, the processing proceeds to step S14. When the control unit 17 determines that the number of passing sheets is smaller than the first number, the processing proceeds to step S13.

In step S14, the control unit 17 determines whether the number of passing sheets is equal to or greater than a second number. When it is determined that the number of passing sheets is equal to or greater than the first number and the number of passing sheets is smaller than the second number, the control unit 17 determines that the state is a second state. The second state is a state where the medium 99 is estimated to be abnormally fed to the nipping position HP by the feeding portion 23 as compared with the first state. The second state is a state where a wear amount of the conveying roller 25 is estimated to be greater than that in the first state. The second number may be, for example, 100,000.

The control unit 17 determines that the state is a third state when it is determined that the number of passing sheets is equal to or greater than the second number. The third state is a state where the medium 99 is estimated to be abnormally fed to the nipping position HP by the feeding portion 23 as compared with the second state. The third state is a state where the wear amount of the conveying roller 25 is estimated to be greater than that in the second state.

When the control unit 17 determines that the number of passing sheets is smaller than the second number, the processing proceeds to step S15. When the control unit 17 determines that the number of passing sheets is equal to or greater than the second number, the processing proceeds to step S16.

In step S13, the control unit 17 executes first time setting processing. In this processing, the control unit 17 sets a first time in a raising time counter. The raising time counter is a time during which the raising and lowering portion 22 raises the stacking portion 21 after the feeding portion 23 is disposed at the detection position DP. The raising time counter may be allocated to the memory.

In step S15, the control unit 17 executes second time setting processing. In this processing, the control unit 17 sets a second time in the raising time counter. The second time is longer than the first time.

In step S16, the control unit 17 executes third time setting processing. In this processing, the control unit 17 sets a third time in the raising time counter. The third time is longer than the second time.

In step S17, the control unit 17 executes raising processing. In this processing, the control unit 17 acquires, as a set time, the time set in the raising time counter in any of the processing of steps S13, S15, and S16. The control unit 17 controls the raising and lowering portion 22 to raise the stacking portion 21 at a predetermined speed.

In step S18, the control unit 17 determines whether the set time has elapsed based on the detection position DP. The control unit 17 determines whether the feeding portion 23 has reached the detection position DP based on a detection signal from the detection unit 24. When it is determined that the feeding portion 23 has reached the detection position DP, the control unit 17 determines whether the set time has elapsed based on the raising time counter. When it is determined that the feeding portion 23 has reached the detection position DP, the control unit 17 may start the subtraction of the raising time counter and determine that the set time has elapsed once the value of the raising time counter is 0.

When it is determined that the set time has elapsed based on the detection position DP, the control unit 17 ends the position adjustment control processing. When the control unit 17 determines that the set time has not elapsed based on the detection position DP, the processing proceeds to step S17 again.

In this manner, when the first time is set in the raising time counter, in the first state, the control unit 17 raises the stacking portion 21 until the first time elapses after the detection unit 24 detects that the feeding portion 23 has been raised to the detection position DP. Accordingly, in the first state, the control unit 17 raises the stacking portion 21 such that the feeding portion 23 is disposed at the first position P1.

When the second time is set in the raising time counter, in the second state, the control unit 17 raises the stacking portion 21 until the second time elapses after the detection unit 24 detects that the feeding portion 23 has been raised to the detection position DP. Accordingly, in the second state, the control unit 17 raises the stacking portion 21 such that the feeding portion 23 is disposed at the second position P2.

When the third time is set in the raising time counter, in the third state, the control unit 17 raises the stacking portion 21 until the third time elapses after the detection unit 24 detects that the feeding portion 23 has been raised to the detection position DP. Accordingly, the control unit 17 raises the stacking portion 21 such that the feeding portion 23 is disposed at the third position P3.

In this manner, the control unit 17 rotates the feeding roller 23a after adjusting the position of the feeding portion 23 in the position adjustment control processing. Accordingly, the control unit 17 causes the medium 99 to be fed such that a leading end of the uppermost medium 99 stacked on the stacking portion 21 faces the nipping position HP.

### Actions and Effects of First Embodiment

Actions and effects of the first embodiment will be described.
(1-1) In the first state, the control unit 17 raises the stacking portion 21 such that the feeding portion 23 is disposed at the first position P1. In the second state, the control unit 17 raises the stacking portion 21 such that the feeding portion 23 is disposed at the second position P2.

According to this configuration, in the second state, a feeding position of the medium 99 can be adjusted by raising the stacking portion 21. Accordingly, it is possible to appropriately feed the medium 99 to the conveying roller 25 and the separation portion 26 without providing a configuration for adjusting the feeding position of the medium 99 separately from the raising and lowering portion 22. Therefore, space saving in the apparatus can be achieved.
(1-2) The control unit 17 determines that the state is the second state when the number of the media 99 conveyed by the conveying roller 25 is equal to or greater than the first number. According to this configuration, it is possible to estimate the wear amount of the conveying roller 25 based on the number of the media 99 conveyed by the conveying roller 25 without newly providing a configuration for actually measuring the wear amount of the conveying roller 25. Therefore, space saving in the apparatus can be achieved.
(1-3) In the first state, the control unit 17 raises the stacking portion 21 such that the feeding portion 23 is disposed at the first position P1 by raising the stacking portion 21 until the first time elapses after the detection unit 24 detects that the feeding portion 23 has been raised to the detection position DP. In the second state, the control unit 17 raises the stacking portion 21 such that the feeding portion 23 is disposed at the second position P2 by raising the stacking portion 21 until the second time elapses after the detection unit 24 detects that the feeding portion 23 has been raised to the detection position DP.

According to this configuration, the feeding portion 23 can be raised to the first position P1 or the second position P2 without providing a configuration that is separate from the detection unit 24 and that detects whether the feeding portion 23 has reached the first position P1 or the second position P2. Specifically, the control unit 17 can raise the stacking portion 21 so as to raise the feeding portion 23 to the first position P1 or the second position P2 based on the elapsed time for raising the stacking portion 21 after the feeding portion 23 is raised to the detection position DP. Therefore, space saving in the apparatus can be achieved.
(1-4) The separation portion 26 is a rotating body that can take the state of being driven by the conveying roller 25 and the state of being stopped or being reversed with respect to the conveying roller 25. According to this configuration, the conveyance of the fed medium 99 and the separation of the plurality of conveyed media 99 in an overlapping manner can be performed with the same configuration. Therefore, space saving in the apparatus can be achieved.
(1-5) The raising and lowering portion 22 may raise and lower the stacking portion 21 by rotating the stacking portion 21 about the rotation axis AL. According to this configuration, even when a stacking angle of the medium 99 stacked on the stacking portion 21 varies depending on a height of the medium 99 stacked on the stacking portion 21, the medium 99 can be appropriately fed to the conveying roller 25 and the separation portion 26.

### Second Embodiment

Next, a second embodiment will be described. In the following description, redundant description is omitted or simplified for the same components as the components in the embodiment described above, and components different from the components in the embodiment described above are described.

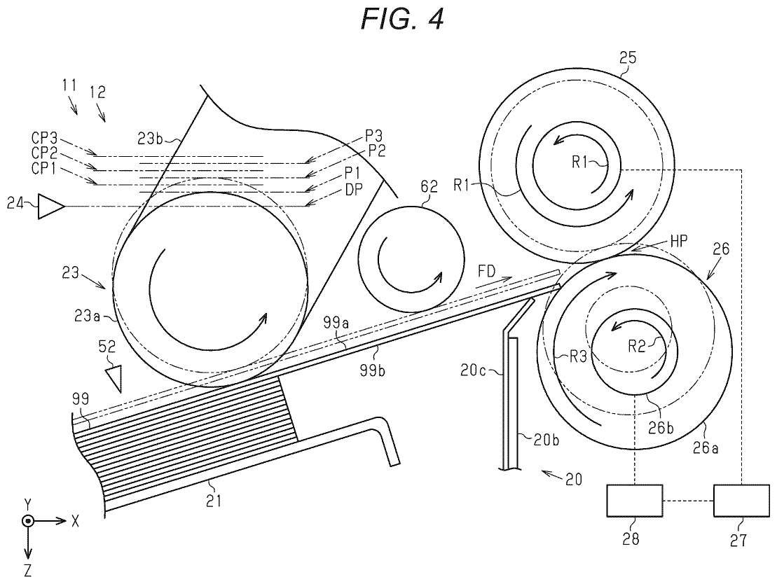

As shown in FIG. 4, in the second embodiment, the medium feeding device 12 may include a second feeding portion 62. The second feeding portion 62 feeds the medium 99 stacked on the stacking portion 21. The feeding portion 23 in the first embodiment may be a first feeding portion. The second feeding portion 62 may be provided between the feeding portion 23 and the conveying roller 25.

When the feeding portion 23 is disposed at the first position P1, the second feeding portion 62 is not in contact with the medium 99 stacked on the stacking portion 21. That is, at the first position P1, the feeding portion 23 alone feeds the medium 99 stacked on the stacking portion 21. When the feeding portion 23 is disposed at the second position P2, the second feeding portion 62 is in contact with the medium 99 stacked on the stacking portion 21. That is, as indicated by a two-dot chain line in FIG. 4, at the second position P2, the feeding portion 23 feeds the medium 99 stacked on the stacking portion 21 together with the second feeding portion 62.

### Actions and Effects of Second Embodiment

Actions and effects of the second embodiment will be described.
(2-1) The second feeding portion 62 is not in contact with the medium 99 stacked on the stacking portion 21 when the feeding portion 23 is disposed at the first position P1, and is in contact with the medium 99 stacked on the stacking portion 21 when the feeding portion 23 is disposed at the second position P2.

According to this configuration, the second feeding portion 62 is less likely to be worn than the feeding portion 23. Accordingly, even when the feeding portion 23 is worn, the medium 99 can be brought into contact with the second feeding portion 62 together with the feeding portion 23 by raising the stacking portion 21 such that the feeding portion is disposed at the second position P2. Accordingly, feeding accuracy of the medium 99 can be maintained.

### Third Embodiment

Next, a third embodiment will be described.

As shown in FIG. 2, in the third embodiment, the medium feeding device 12 may include a measurement unit 52. That is, the recording apparatus 11 may include the measurement unit 52. The measurement unit 52 may be provided in the vicinity of the medium 99 accommodated in the cassette 20.

The measurement unit 52 measures humidity. The measurement unit 52 may output, to the control unit 17, a detection signal indicating the humidity. The measurement unit 52 may output, to the control unit 17, a detection signal indicating whether the humidity is equal to or greater than specified humidity. The control unit 17 may determine the set time based on the humidity measured by the measurement unit 52.

### Position Adjustment Control Processing

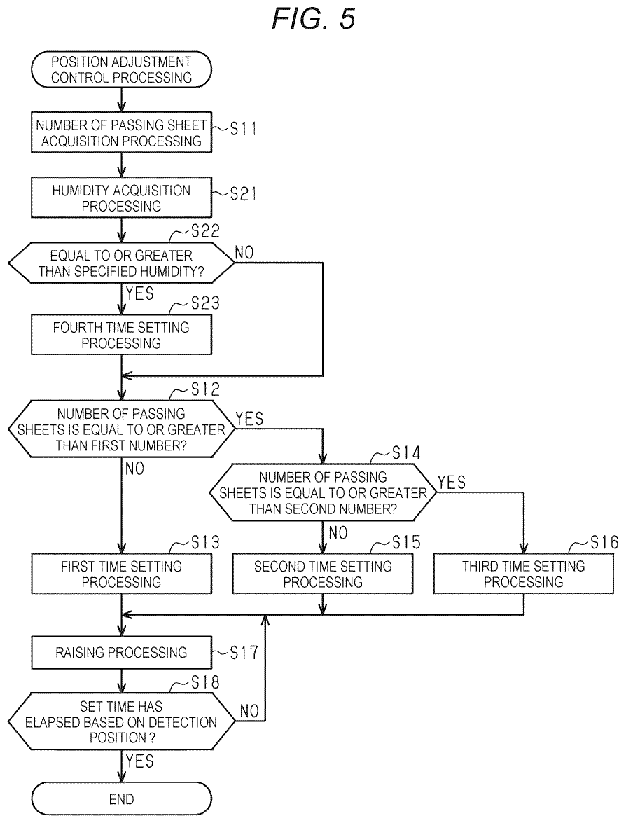

As shown in FIG. 5, when step S11 ends, the control unit 17 proceeds the processing to step S21. In step S21, the control unit 17 executes humidity acquisition processing. In this processing, the control unit 17 acquires the humidity based on the detection signal from the measurement unit 52.

In step S22, the control unit 17 determines whether the humidity is equal to or greater than the specified humidity. The specified humidity may be stored in the memory in advance. When it is determined that the humidity is equal to or greater than the specified humidity, the control unit 17 determines that a first correction condition is satisfied. When it is determined that the humidity is smaller than the specified humidity, the control unit 17 determines that the first correction condition is not satisfied.

The first correction condition includes a condition that the leading end of the medium 99 fed by the feeding portion 23 is estimated to be lower than the nipping position HP. The first correction condition includes that the humidity measured by the measurement unit 52 is equal to or greater than the specified humidity.

When the control unit 17 determines that the humidity is equal to or greater than the specified humidity, the processing proceeds to step S23. When the control unit 17 determines that the humidity is smaller than the specified humidity, the processing proceeds to step S12.

In step S23, the control unit 17 executes fourth time setting processing. In this processing, the control unit 17 sets a fourth time in the raising time counter. The fourth time is shorter than the first time, but may be longer than the first time or may be the same as the first time.

In step S13, the control unit 17 adds the first time to the raising time counter. In step S15, the control unit 17 adds the second time to the raising time counter. In step S16, the control unit 17 adds the third time to the raising time counter.

In this manner, when the fourth time is set in the raising time counter in step S23, the control unit 17 sets, as the set time, a total time of the fourth time and the first time, the second time, or the third time. When the fourth time is not set in the raising time counter in step S23, the control unit 17 sets the first time, the second time, or the third time as the set time.

A specific example in which the fourth time is set in the raising time counter in step S23 and the first time is added to the raising time counter in step S13 will be described. In such a case, when it is determined that the first correction condition is satisfied in the first state, the control unit 17 raises the stacking portion 21 such that the feeding portion 23 is disposed at a first correction position CP1 in FIG. 2. The first correction position CP1 may be a position above the first position P1.

A specific example in which the fourth time is set in the raising time counter in step S23 and the second time is added to the raising time counter in step S15 will be described. In such a case, when it is determined that the first correction condition is satisfied in the second state, the control unit 17 raises the stacking portion 21 such that the feeding portion 23 is disposed at a second correction position CP2 in FIG. 2. The second correction position CP2 may be a position above the first correction position CP1 and above the second position P2.

A specific example in which the fourth time is not set in the raising time counter in step S23 and the first time is added to the raising time counter in step S13 will be described. In such a case, when the first correction condition is not satisfied in the first state, the control unit 17 raises the stacking portion 21 such that the feeding portion 23 is disposed at the first position P1.

### Actions and Effects of Third Embodiment

Actions and effects of the third embodiment will be described.
(3-1) When the first correction condition is not satisfied in the first state, the control unit 17 raises the stacking portion 21 such that the feeding portion 23 is disposed at the first position P1. When the first correction condition is satisfied, the control unit 17 raises the stacking portion 21 such that the feeding portion 23 is disposed at the first correction position CP1 above the first position P1.

According to this configuration, even when the leading end of the medium 99 fed by the feeding portion 23 is estimated to be lower than the nipping position HP, by raising the stacking portion 21, the medium 99 can be appropriately fed such that the leading end of the medium 99 faces the nipping position HP. Accordingly, it is possible to appropriately feed the medium 99 to the conveying roller 25 and the separation portion 26 without providing a configuration for adjusting the feeding position of the medium 99 separately from the raising and lowering portion 22. Therefore, space saving in the apparatus can be achieved.
(3-2) The medium feeding device 12 further includes the measurement unit 52 that measures the humidity, and the first correction condition includes that the humidity measured by the measurement unit 52 is equal to or greater than the specified humidity. According to this configuration, even when the humidity is equal to or greater than the specified humidity, by raising the stacking portion 21, the medium 99 can be appropriately fed such that the leading end of the medium 99 faces the nipping position HP.

### Fourth Embodiment

Next, a fourth embodiment will be described.

In the fourth embodiment, the control unit 17 may determine the set time based on the type of the medium 99. For example, the control unit 17 may determine that the first correction condition is satisfied based on the type of the medium 99.

### Position Adjustment Control Processing

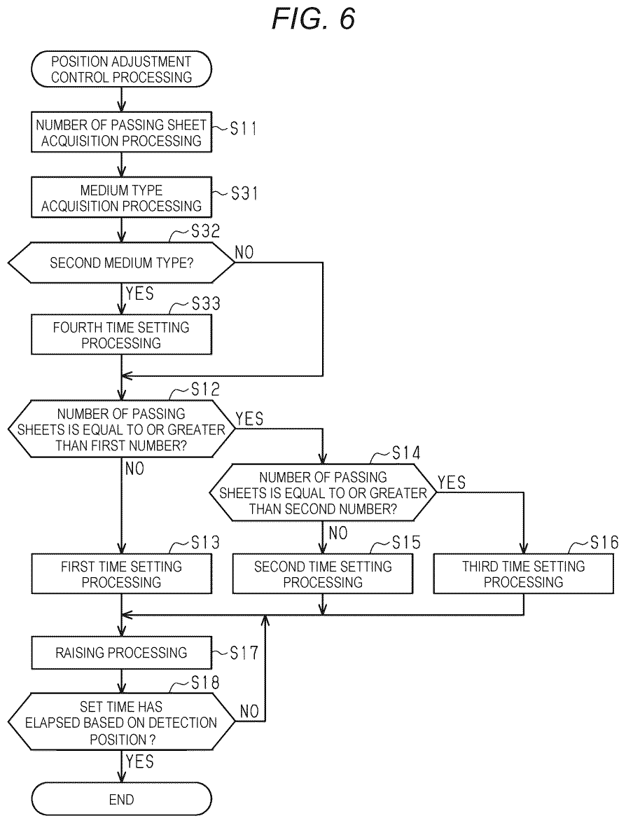

As shown in FIG. 6, when step S11 ends, the control unit 17 proceeds the processing to step S31. In step S31, the control unit 17 executes medium type acquisition processing. In this processing, the control unit 17 acquires the type of the medium 99 based on an instruction from the user. The type of the medium 99 is specified by the instruction from the user. For example, the control unit 17 may acquire the type of the medium 99 based on information received through the operation panel 16. The control unit 17 may acquire the type of the medium 99 based on information of the recording start instruction. The control unit 17 may acquire the type of the medium 99 by controlling a medium type detection unit (not shown).

In step S32, the control unit 17 determines whether the acquired type of the medium 99 is a second medium type. The second medium type is a medium having flexural rigidity lower than that of a first medium type. That is, the second medium type is easier to bend than the first medium type. In particular, the leading end of the medium 99 of the second medium type fed by the feeding portion 23 is likely to be below the nipping position HP.

When the control unit 17 determines that the acquired type of the medium 99 is the second medium type, the processing proceeds to step S33. When the control unit 17 determines that the acquired type of the medium 99 is not the second medium type, the processing proceeds to step S12.

In step S33, the control unit 17 executes the fourth time setting processing as in step S23 in the third embodiment. In this processing, the control unit 17 sets the fourth time in the raising time counter.

### Actions and Effects of Fourth Embodiment

Actions and effects of the fourth embodiment will be described.
(4-1) The control unit 17 determines whether the first correction condition is satisfied based on the type of the medium 99 fed by the feeding portion 23. According to this configuration, it can be estimated that the leading end of the medium 99 fed by the feeding portion 23 is lowered depending on the type of the medium 99.

### Fifth Embodiment

Next, a fifth embodiment will be described.

In the fifth embodiment, the control unit 17 may determine the set time based on the type of the medium 99 and a position of the medium 99 on the stacking portion 21. The position on the stacking portion 21 may be, for example, the height of the medium 99 on the stacking portion 21. In particular, the control unit 17 may determine the set time based on whether the medium type is a third medium type. In the third medium type, the medium 99 includes at least two media. The third medium type may be, for example, an envelope.

### Position Adjustment Control Processing

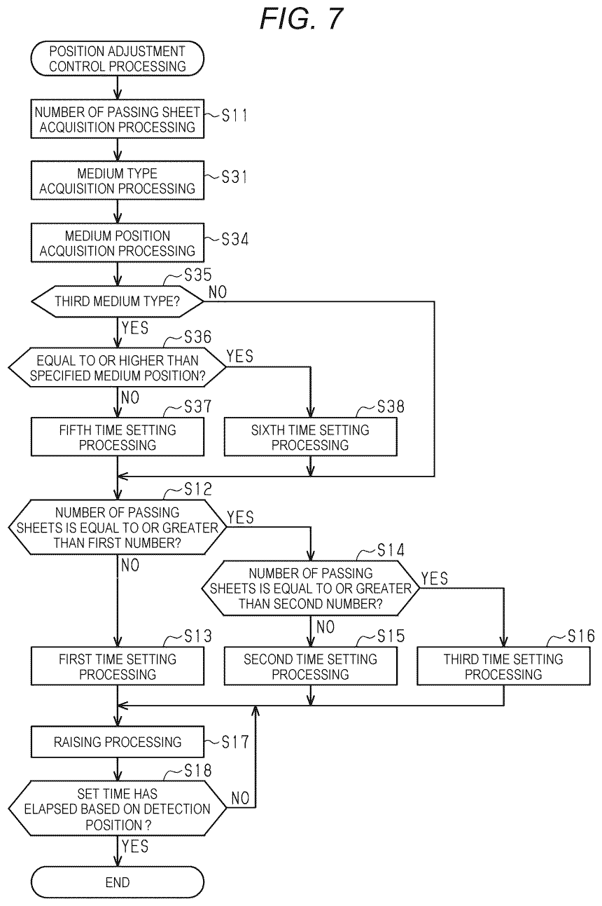

As shown in FIG. 7, when step S31 ends, the control unit 17 proceeds the processing to step S34. In step S34, the control unit 17 executes medium position acquisition processing. In this processing, the control unit 17 acquires the position of the medium 99 based on a detection signal from a medium position detection unit (not shown). The control unit 17 acquires the position of the medium 99 in the Z direction. The control unit 17 may acquire the position of the medium 99 based on a raising amount of the stacking portion 21 by the raising and lowering portion 22.

The medium feeding device 12 includes the medium position detection unit. The medium position detection unit may output, to the control unit 17, a detection signal indicating whether the position of the medium 99 stacked on the stacking portion 21 is equal to or higher than a specified medium position. The medium position detection unit may output, to the control unit 17, a detection signal indicating the position of the medium 99 stacked on the stacking portion 21. The medium position detection unit is, for example, an optical sensor, or may be a contact sensor, and may detect a thickness of the medium 99 by ultrasonic waves.

In step S35, the control unit 17 determines whether the acquired type of the medium 99 is the third medium type. When it is determined that the type of the medium 99 is the third medium type, the control unit 17 determines that a second correction condition is satisfied. When it is determined that the type of the medium 99 is not the third medium type, the control unit 17 determines that the second correction condition is not satisfied. The second correction condition includes that the medium 99 is estimated to be pressed down along with the feeding by the feeding portion 23.

Specifically, when the feeding roller 23a comes into contact with the first surface 99a and conveys the medium 99, a force pressing down in a direction toward the medium 99 acts on the feeding portion 23. When the medium 99 is of the third medium type, a gap between the media constituting the medium 99 may be crushed. That is, when the medium 99 is of the third medium type, the medium 99 may be pressed down along with the feeding by the feeding portion 23.

When the control unit 17 determines that the acquired type of the medium 99 is the third medium type, the processing proceeds to step S36. When the control unit 17 determines that the acquired type of the medium 99 is not the third medium type, the processing proceeds to step S12.

In step S36, the control unit 17 determines whether the detected position of the medium 99 is equal to or higher than the specified medium position. The specified medium position may be a position at which the medium 99 fed by the feeding portion 23 is nipped by the conveying roller 25 and the separation portion 26. The specified medium position may be stored in the memory in advance.

When it is determined that the position of the medium 99 is equal to or higher than the specified medium position, the control unit 17 determines that a third correction condition is satisfied. When it is determined that the position of the medium 99 is lower than the specified medium position, the control unit 17 determines that the third correction condition is not satisfied. The third correction condition includes that the height of the medium 99 stacked on the stacking portion 21 is equal to or higher than the specified medium position.

When the position of the medium 99 of the third medium type is equal to or higher than the specified medium position, the height at which the medium 99 is pressed down along with the feeding by the feeding portion 23 is greater than that in a case where the position of the medium 99 of the third medium type is lower than the specified medium position.

When the control unit 17 determines that the position of the medium 99 is lower than the specified medium position, the processing proceeds to step S37. When the control unit 17 determines that the position of the medium 99 is equal to or higher than the specified medium position, the processing proceeds to step S38.

In step S37, the control unit 17 executes fifth time setting processing. In this processing, the control unit 17 sets a fifth time in the raising time counter. The fifth time may be longer than the first time.

In step S38, the control unit 17 executes sixth time setting processing. In this processing, the control unit 17 sets a sixth time in the raising time counter. The sixth time may be longer than the fifth time.

A specific example in which the fifth time is set in the raising time counter in step S37 and the first time is added to the raising time counter in step S13 will be described. In such a case, when the second correction condition is satisfied but the third correction condition is not satisfied in the first state, the control unit 17 raises the stacking portion 21 such that the feeding portion 23 is disposed at the first correction position CP1.

A specific example in which the sixth time is set in the raising time counter in step S38 and the first time is added to the raising time counter in step S13 will be described. In such a case, when the second correction condition and the third correction condition are satisfied in the first state, the control unit 17 raises the stacking portion 21 such that the feeding portion 23 is disposed at the second correction position CP2.

A specific example in which the fifth time is set in the raising time counter in step S37 and the second time is added to the raising time counter in step S15 will be described. In such a case, when the second correction condition is satisfied but the third correction condition is not satisfied in the second state, the control unit 17 raises the stacking portion 21 such that the feeding portion 23 is disposed at the second correction position CP2.

A specific example in which the sixth time is set in the raising time counter in step S38 and the second time is added to the raising time counter in step S15 will be described. In such a case, when the second correction condition and the third correction condition are satisfied in the second state, the control unit 17 raises the stacking portion 21 such that the feeding portion 23 is disposed at a third correction position CP3. The third correction position CP3 may be a position above the second correction position CP2 and above the third position P3.

A specific example of a case where the fifth time is not set in the raising time counter in step S37, the sixth time is not set in the raising time counter in step S38, and the first time is added to the raising time counter in step S13 will be described. In such a case, when the second correction condition is not satisfied in the first state, the control unit 17 raises the stacking portion 21 such that the feeding portion 23 is disposed at the first position P1.

### Actions and Effects of Fifth Embodiment

Actions and effects of the fifth embodiment will be described.
(5-1) When the second correction condition is not satisfied in the first state, the control unit 17 raises the stacking portion 21 such that the feeding portion 23 is disposed at the first position P1. When the second correction condition is satisfied, the control unit 17 raises the stacking portion 21 such that the feeding portion 23 is disposed at the first correction position CP1 or the second correction position CP2.

According to this configuration, even when the medium 99 is estimated to be pressed down along with the feeding by the feeding portion 23, by raising the stacking portion 21, the medium 99 can be appropriately fed such that the leading end of the medium 99 faces the nipping position HP.
(5-2) In the first state, when the second correction condition is satisfied but the third correction condition is not satisfied, the control unit 17 raises the stacking portion 21 such that the feeding portion 23 is disposed at the first correction position CP1. When the second correction condition and the third correction condition are satisfied, the control unit 17 raises the stacking portion 21 such that the feeding portion 23 is disposed at the second correction position CP2.

According to this configuration, when the height of the medium 99 stacked on the stacking portion 21 is equal to or higher than the specified medium position and the medium 99 is estimated to be pressed down, by raising the stacking portion 21, the medium 99 can be appropriately fed such that the leading end of the medium 99 faces the nipping position HP.

### Modifications

The embodiment can be implemented with the following modifications. The embodiment and the following modifications can be implemented in combination with each other as long as no technical inconsistencies are involved.

In the second embodiment, the second feeding portion 62 may not be in contact with the medium 99 stacked on the stacking portion 21 when the feeding portion 23 is disposed at the first position P1 and the second position P2, and may be in contact with the medium 99 stacked on the stacking portion 21 when the feeding portion 23 is disposed at the third position P3.

In the second embodiment, the second feeding portion 62 may rotate in conjunction with the feeding portion 23. The second feeding portion 62 may rotate in the same phase as the feeding portion 23. The second feeding portion 62 may rotate even when the second feeding portion 62 is in contact with the medium 99 but does not convey the medium 99. In the third embodiment, the fourth embodiment, and the fifth embodiment, the medium feeding device 12 may also include the second feeding portion 62.

In the third embodiment, a plurality of values of specified humidity may be provided as plural. The control unit 17 may determine the set time corresponding to the plurality of values of specified humidity based on the humidity measured by the measurement unit 52.

In the third embodiment, the measurement unit 52 may measure a temperature in the medium feeding device 12. The measurement unit 52 may output, to the control unit 17, a detection signal indicating the temperature. The measurement unit 52 may output, to the control unit 17, a detection signal indicating whether the temperature is equal to or higher than a specified temperature. The control unit 17 may determine the set time based on the temperature measured by the measurement unit 52. The measurement unit 52 may include a temperature measurement unit that measures the temperature in the medium feeding device 12 and a humidity measurement unit that measures the humidity in the medium feeding device 12.

In the third embodiment, the control unit 17 may determine the set time based on at least one parameter of the acquired humidity, the acquired temperature, and the type of the medium 99 based on the detection signal from the measurement unit 52. The control unit 17 may receive these pieces of information from the operation panel 16 by the user.

In the third embodiment, the fourth embodiment, and the fifth embodiment, the type of the medium 99 includes a paper thickness, rigidity, a basis weight, and a grain direction.

In the third embodiment and the fourth embodiment, the first correction condition may be satisfied when the type of the medium 99 is the second medium type and the humidity is equal to or greater than the specified humidity. Accordingly, in the first state, when the type of the medium 99 is the second medium type and the humidity is equal to or greater than the specified humidity, the control unit 17 may raise the stacking portion 21 such that the feeding portion 23 is disposed at the first correction position CP1.

In the third embodiment and the fourth embodiment, the first correction condition may include a condition under which the medium 99 fed by the feeding portion 23 is estimated to come into contact with the separation roller 26a at a certain angle or more. The certain angle or more may be, for example, a case where a contact angle between the medium 99 fed by the feeding portion 23 and the separation roller 26a is 54 degrees or more.

In the fifth embodiment, the third correction condition may not include that the height of the medium 99 stacked on the stacking portion 21 is equal to or higher than the specified medium position. In this case, the control unit 17 may set the set time according to the type or the number of the media 99 input by the user in the raising time counter. In the fifth embodiment, the control unit 17 may determine whether the second correction condition is satisfied without determining whether the third correction condition is satisfied.

In the fifth embodiment, in the third medium type, the medium 99 may include at least two media. The third medium type may include three or more of the media 99. The third medium type may be, for example, a medicine bag or a paper bag other than the envelope.

In the third embodiment, the fourth embodiment, and the fifth embodiment, the first correction position CP1 may be a position higher than the second position P2. The second correction position CP2 may be a position higher than the third position P3.

In the third embodiment and the fourth embodiment, the correction position at which the feeding portion 23 is disposed may have three or more stages. In the fifth embodiment, the correction position at which the feeding portion 23 is disposed may have two stages or four or more stages. The position where the feeding portion 23 is disposed may have two stages or four or more stages.

The medium feeding device 12 may include a wear measurement unit that measures the wear amount of the conveying roller 25. The control unit 17 may perform the position adjustment control processing based on the wear amount of the conveying roller 25 measured by the wear measurement unit. In this case, the control unit 17 may not perform the number of passing sheet acquisition processing in step S11. The control unit 17 may estimate the wear amount of the conveying roller 25 based on the number of conveying errors. The control unit 17 may acquire the wear amount of the conveying roller 25 by the user operating the operation panel 16.

The medium feeding device 12 may include one or more sensors that detect the position of the feeding portion 23 separately from the detection unit 24. In this case, the control unit 17 may not set the set time in the raising time counter.

The control unit 17 may estimate the wear amount of the conveying roller 25 using, as a new number of passing sheets, a value obtained by multiplying the actual number of passing sheets by a coefficient depending on the type of the medium 99 or the conveying speed of the medium 99.

When it is determined that the number is equal to or greater than a third number greater than the second number, the control unit 17 may raise and lower the stacking portion 21 for a time longer than the third time. The first number, the second number, and the third number may or may not be provided at equal intervals. That is, the first number, the second number, and the third number may or may not be in a proportional relationship. An interval between the first number and the second number may be smaller than an interval between the second number and the third number.

The raising and lowering portion 22 may raise and lower the stacking portion 21 along the vertical direction Z in a horizontal state. The raising and lowering portion 22 may raise and lower the stacking portion 21 inclined upward with respect to the width direction X along the vertical direction Z.

The separation portion 26 is not limited to a roller. The separation portion 26 may be a pad having a constant frictional force. The pad may be provided on the guide portion 20c. The separation portion 26 may be biased by the conveying roller 25. At this time, when the medium 99 stacked on the stacking portion 21 is a medium that is likely to be multi-fed, the control unit 17 may adjust a height of the stacking portion 21 such that the leading end of the medium 99 comes into contact with the pad provided on the guide portion 20c. Accordingly, the multi-feeding of the medium 99 is prevented.

When the medium 99 stacked on the stacking portion 21 is the final sheet, the control unit 17 may move the feeding portion 23 in a direction approaching the medium 99. Accordingly, the non-feeding of the medium 99 is prevented by increasing a frictional force between the feeding roller 23a and the medium 99.

When the medium 99 stacked on the stacking portion 21 is a medium that is likely to be multi-fed, the control unit 17 may move the feeding portion 23 in a direction away from the medium 99. Accordingly, the multi-feeding of the medium 99 is prevented by reducing the frictional force between the feeding roller 23a and the medium 99.

The medium feeding device 12 may include the conveying portion 13. The medium feeding device 12 may be configured to feed the medium 99 stacked on the stacking portion 21 to the conveying portion 13 and convey the medium 99 to a recording apparatus (not shown) by the conveying portion 13.

The medium 99 may be a sheet, a resin film or sheet, a composite film of a resin and a metal, a laminated film, a woven fabric, a nonwoven fabric, a metal foil, a metal film, a ceramic sheet, clothing, or the like.

Any liquid can be optionally selected as long as the liquid adheres to the medium 99 to enable recording on the medium 99. The liquid may be a dye ink such as a disperse dye ink or a reactive dye ink. For example, the ink includes an ink in which particles of a functional material including a solid matter such as pigment or metal particles are dissolved, dispersed, or mixed in a solvent and includes various compositions such as an aqueous ink, an oil-based ink, a gel ink, and a hot melt ink.

A lateral printer may be adopted as the recording apparatus 11. The lateral printer is a printer in which a carriage is movable in two directions of a main scanning direction and a sub scanning direction. The recording apparatus 11 is not limited to the inkjet printer and may be a dot impact printer. The recording apparatus 11 may be a laser printer.

The expression “at least any one of” used in the present specification means one or more of desired choices. As an example, when the number of choices is two, the expression “at least any one of” used in the present specification means only one choice or both of the two choices. As another example, when the number of choices is three or more, the expression “at least any one of” used in the present specification means only one choice or a combination of two or more any choices.

### Appendix

Technical ideas figured out from the embodiments and the modifications described above and action effects thereof are described below. The technical ideas and the action effects thereof can be combined with each other within a range where no technical contradictions are involved.
[1] A medium feeding device includes: a stacking portion on which a medium is stacked; a feeding portion configured to feed the medium stacked on the stacking portion; a conveying roller configured to convey the medium fed by the feeding portion; a separation portion configured to nip the medium together with the conveying roller to separate the medium; a raising and lowering portion configured to raise and lower the stacking portion; and a control unit configured to control the raising and lowering portion, in which the feeding portion rises by coming into contact with the medium stacked on the stacking portion as the stacking portion is raised by the raising and lowering portion, and in a first state, the control unit raises the stacking portion such that the feeding portion is disposed at a first position, and in a second state where a wear amount of the conveying roller is estimated to be greater than a wear amount in the first state, the control unit raises the stacking portion such that the feeding portion is disposed at a second position above the first position.

According to this configuration, in the second state where the wear amount of the conveying roller is estimated to be large, a feeding position of the medium can be adjusted by raising the stacking portion. Accordingly, it is possible to appropriately feed the medium to the conveying roller and the separation portion without providing a configuration for adjusting the feeding position of the medium separately from the raising and lowering portion. Therefore, space saving in the apparatus can be achieved.
[2] In the medium feeding device, the control unit may determine that the state is the second state when the number of media conveyed by the conveying roller is equal to or greater than a first number. According to this configuration, it is possible to estimate the wear amount of the conveying roller based on the number of the media conveyed by the conveying roller without newly providing a configuration for actually measuring the wear amount of the conveying roller. Therefore, space saving in the apparatus can be achieved.
[3] The medium feeding device may further include: a detection unit configured to detect that the feeding portion has been raised to a detection position, in which in the first state, the control unit may raise the stacking portion such that the feeding portion is disposed at the first position by raising the stacking portion until a first time elapses after the detection unit detects that the feeding portion has been raised to the detection position, and in the second state, the control unit may raise the stacking portion such that the feeding portion is disposed at the second position by raising the stacking portion until a second time longer than the first time elapses after the detection unit detects that the feeding portion has been raised to the detection position.

According to this configuration, even when a configuration for detecting whether the feeding portion has reached the first position or the second position is not provided separately from the detection unit, the feeding portion can be raised to the first position or the second position based on the elapsed time for raising the stacking portion after the feeding portion is raised to the detection position. Therefore, space saving in the apparatus can be achieved.
[4] In the medium feeding device, the separation portion may be a rotating body configured to take a state of being driven by the conveying roller and a state of being stopped or being reversed with respect to the conveying roller.

According to this configuration, the conveyance of the fed medium and the separation of a plurality of conveyed media in an overlapping manner can be performed with the same configuration. Therefore, space saving in the apparatus can be achieved.
[5] The medium feeding device may further include: a second feeding portion configured to feed the medium stacked on the stacking portion, in which the second feeding portion may not be in contact with the medium stacked on the stacking portion when the feeding portion is disposed at the first position, and may be in contact with the medium stacked on the stacking portion when the feeding portion is disposed at the second position.

According to this configuration, the second feeding portion is less likely to be worn than the feeding portion. Accordingly, even when the feeding portion is worn, the medium can be brought into contact with the second feeding portion together with the feeding portion by raising the stacking portion such that the feeding portion is disposed at the second position. Accordingly, feeding accuracy of the medium can be maintained.
[6] In the medium feeding device, in the first state, when a first correction condition is not satisfied, the control unit may raise the stacking portion such that the feeding portion is disposed at the first position, and when the first correction condition is satisfied, the control unit may raise the stacking portion such that the feeding portion is disposed at a first correction position above the first position, and the first correction condition may include a condition that a leading end of the medium fed by the feeding portion is estimated to be lower than a nipping position at which the medium is nipped by the conveying roller and the separation portion.

According to this configuration, even when the leading end of the medium fed by the feeding portion is estimated to be lower than the nipping position, by raising the stacking portion, the medium can be appropriately fed such that the leading end of the medium faces the nipping position. Accordingly, it is possible to appropriately feed the medium to the conveying roller and the separation portion without providing a configuration for adjusting the feeding position of the medium separately from the raising and lowering portion. Therefore, space saving in the apparatus can be achieved.
[7] In the medium feeding device, the control unit may determine whether the first correction condition is satisfied based on a type of the medium fed by the feeding portion. According to this configuration, it can be estimated that the leading end of the medium fed by the feeding portion is lowered depending on the type of the medium.
[8] The medium feeding device may further include a measurement unit configured to measure humidity, in which the first correction condition may include that the humidity measured by the measurement unit is equal to or greater than specified humidity. According to this configuration, even when the humidity is equal to or greater than the specified humidity, by raising the stacking portion, the medium can be appropriately fed such that the leading end of the medium faces the nipping position.
[9] In the medium feeding device, in the first state, when a second correction condition is not satisfied, the control unit may raise the stacking portion such that the feeding portion is disposed at the first position, and when the second correction condition is satisfied, the control unit may raise the stacking portion such that the feeding portion is disposed at a first correction position above the first position, and the second correction condition may include that the medium is estimated to be pressed down along with feeding by the feeding portion.

According to this configuration, even when the medium is estimated to be pressed down along with the feeding by the feeding portion, by raising the stacking portion, the medium can be appropriately fed such that the leading end of the medium faces the nipping position.
[10] In the medium feeding device, in the first state, when the second correction condition is satisfied but a third correction condition is not satisfied, the control unit may raise the stacking portion such that the feeding portion is disposed at the first correction position, and when the second correction condition and the third correction condition are satisfied, the control unit may raise the stacking portion such that the feeding portion is disposed at a second correction position above the first correction position, and the third correction condition may include that a height of the medium stacked on the stacking portion is equal to or higher than a specified medium position.

According to this configuration, even when the height of the medium stacked on the stacking portion is equal to or higher than the specified medium position and the medium is estimated to be pressed down, by raising the stacking portion, the medium can be appropriately fed such that the leading end of the medium faces the nipping position.
[11] In the medium feeding device, the feeding portion may feed the medium in a feeding direction, the stacking portion may be rotatable about a rotation axis, the rotation axis may intersect the feeding direction and a vertical direction, and the raising and lowering portion may raise and lower the stacking portion by rotating the stacking portion about the rotation axis.

According to this configuration, even when a stacking angle of the medium stacked on the stacking portion varies depending on the height of the medium stacked on the stacking portion, the medium can be appropriately fed to the conveying roller and the separation portion by disposing the feeding portion at the first position or the second position.
[12] A recording apparatus includes: a stacking portion on which a medium is stacked; a feeding portion configured to feed the medium stacked on the stacking portion; a conveying roller configured to convey the medium fed by the feeding portion; a separation portion configured to nip the medium together with the conveying roller to separate the medium; a raising and lowering portion configured to raise and lower the stacking portion; a recording unit configured to perform recording on the medium conveyed by the conveying roller; and a control unit configured to control the recording unit and the raising and lowering portion, in which the feeding portion rises by coming into contact with the medium stacked on the stacking portion as the stacking portion is raised by the raising and lowering portion, and in a first state, the control unit raises the stacking portion such that the feeding portion is disposed at a first position, and in a second state where a wear amount of the conveying roller is estimated to be greater than a wear amount in the first state, the control unit raises the stacking portion such that the feeding portion is disposed at a second position above the first position. According to this configuration, it is possible to achieve the same effects as the effects in [1].

What is claimed is:

1. A medium feeding device comprising:
a stacking portion on which a medium is stacked;
a feeding portion configured to feed the medium stacked on the stacking portion;
a conveying roller configured to convey the medium fed by the feeding portion;
a separation portion configured to nip the medium together with the conveying roller to separate the medium;
a raising and lowering portion configured to raise and lower the stacking portion; and
a control unit configured to control the raising and lowering portion, wherein
the feeding portion rises by coming into contact with the medium stacked on the stacking portion as the stacking portion is raised by the raising and lowering portion, and
the control unit
in a first state, raises the stacking portion such that the feeding portion is disposed at a first position, and
in a second state where a wear amount of the conveying roller is estimated to be greater than a wear amount in the first state, raises the stacking portion such that the feeding portion is disposed at a second position above the first position.

2. The medium feeding device according to claim 1, wherein
the control unit determines that the state is the second state when the number of media conveyed by the conveying roller is equal to or greater than a first number.

3. The medium feeding device according to claim 1, further comprising:
a detection unit configured to detect that the feeding portion has been raised to a detection position, wherein
the control unit
in the first state, raises the stacking portion such that the feeding portion is disposed at the first position by raising the stacking portion until a first time elapses after the detection unit detects that the feeding portion has been raised to the detection position, and
in the second state, raises the stacking portion such that the feeding portion is disposed at the second position by raising the stacking portion until a second time longer than the first time elapses after the detection unit detects that the feeding portion has been raised to the detection position.

4. The medium feeding device according to claim 1, wherein
the separation portion is a rotating body configured to take a state of being driven by the conveying roller and a state of being stopped or being reversed with respect to the conveying roller.

5. The medium feeding device according to claim 1, further comprising:
a second feeding portion configured to feed the medium stacked on the stacking portion, wherein
the second feeding portion is not in contact with the medium stacked on the stacking portion when the feeding portion is disposed at the first position, and is in contact with the medium stacked on the stacking portion when the feeding portion is disposed at the second position.

6. The medium feeding device according to claim 1, wherein
in the first state, when a first correction condition is not satisfied, the control unit raises the stacking portion such that the feeding portion is disposed at the first position, and when the first correction condition is satisfied, the control unit raises the stacking portion such that the feeding portion is disposed at a first correction position above the first position, and
the first correction condition includes a condition that a leading end of the medium fed by the feeding portion is estimated to be lower than a nipping position at which the medium is nipped by the conveying roller and the separation portion.

7. The medium feeding device according to claim 6, wherein
the control unit determines whether the first correction condition is satisfied based on a type of the medium fed by the feeding portion.

8. The medium feeding device according to claim 6, further comprising:
a measurement unit configured to measure humidity, wherein
the first correction condition includes that the humidity measured by the measurement unit is equal to or greater than specified humidity.

9. The medium feeding device according to claim 1, wherein
in the first state, when a second correction condition is not satisfied, the control unit raises the stacking portion such that the feeding portion is disposed at the first position, and when the second correction condition is satisfied, the control unit raises the stacking portion such that the feeding portion is disposed at a first correction position above the first position, and
the second correction condition includes that the medium is estimated to be pressed down along with feeding by the feeding portion.

10. The medium feeding device according to claim 9, wherein
in the first state, when the second correction condition is satisfied but a third correction condition is not satisfied, the control unit raises the stacking portion such that the feeding portion is disposed at the first correction position, and when the second correction condition and the third correction condition are satisfied, the control unit raises the stacking portion such that the feeding portion is disposed at a second correction position above the first correction position, and
the third correction condition includes that a height of the medium stacked on the stacking portion is equal to or higher than a specified medium position.

11. The medium feeding device according to claim 1, wherein
the feeding portion feeds the medium in a feeding direction,
the stacking portion is rotatable about a rotation axis,
the rotation axis intersects the feeding direction and a vertical direction, and
the raising and lowering portion raises and lowers the stacking portion by rotating the stacking portion about the rotation axis.

12. A recording apparatus comprising:
a stacking portion on which a medium is stacked;
a feeding portion configured to feed the medium stacked on the stacking portion;
a conveying roller configured to convey the medium fed by the feeding portion;
a separation portion configured to nip the medium together with the conveying roller to separate the medium;
a raising and lowering portion configured to raise and lower the stacking portion;
a recording unit configured to perform recording on the medium conveyed by the conveying roller; and
a control unit configured to control the recording unit and the raising and lowering portion, wherein
the feeding portion rises by coming into contact with the medium stacked on the stacking portion as the stacking portion is raised by the raising and lowering portion, and
the control unit
in a first state, raises the stacking portion such that the feeding portion is disposed at a first position, and
in a second state where a wear amount of the conveying roller is estimated to be greater than a wear amount in the first state, raises the stacking portion such that the feeding portion is disposed at a second position above the first position.
